(19) United States
(12) Patent Application Publication
(10) Pub. No.: US 2023/0091764 A1
(43) Pub. Date: Mar. 23, 2023

(54) MACHINE TOOL

(71) Applicant: FANUC CORPORATION, Minamitsuru-gun (JP)

(72) Inventor: Yuuta TOOYAMA, Minamitsuru-gun, Yamanashi-ken (JP)

(21) Appl. No.: 17/802,417

(22) PCT Filed: Feb. 26, 2021
(86) PCT No.: PCT/JP2021/007416

§ 371 Date: Aug. 25, 2022

(30) Foreign Application Priority Data
Feb. 27, 2020 (JP) 2020-031885

(51) Int. Cl. B23Q 1/25

(52) U.S. Cl. CPC B23Q 1/25

(57) ABSTRACT

Provided is a machine tool having increased stiffness. A machine tool of one embodiment is provided with: a base provided on an installation face of a bed and including a first installation portion on which a guiding rail for guiding a saddle in a first direction is installed, and a second installation portion provided on one end side of the guiding rail and having a column installed thereon; and a flow path which is provided on the installation face of the bed and which drains a liquid dripping from the first installation portion toward the second installation portion via an outer side of a lateral wall of the first installation portion in a second direction. The second installation portion includes a protruding portion that protrudes beyond the lateral wall of the first installation portion in the second direction. The protruding portion has formed therein a through hole through which the flow path passes.

### TECHNICAL FIELD

The present invention relates to a machine tool for machining a workpiece using a tool.

### BACKGROUND ART

JP 5638112 B1 discloses a machine tool including a saddle that moves relative to a bed, a table that moves relative to the saddle, a spindle head (spindle) that moves relative to the table, and a column that supports the spindle head. In this machine tool, a column is installed on a pedestal that protrudes from an installation surface of the bed, and the pedestal and the column are joined by bolts (see FIGS. 2 and 4, etc.).

### SUMMARY OF THE INVENTION

However, in the machine tool disclosed in JP 5638112 B1, since the joint portion between the pedestal and the column protrudes from the pedestal toward the bed side, there is a concern that the rigidity of the pedestal on which the column is installed may decrease.

It is therefore an object of the present invention to provide a machine tool capable of increasing rigidity.

According to an aspect of the present invention, there is provided a machine tool including: a saddle configured to move relative to a bed in a first direction; a table configured to move relative to the saddle in a second direction intersecting with the first direction; a spindle head configured to move relative to the table in a third direction intersecting with the first direction and the second direction; and a column configured to support the spindle head, wherein the machine tool further includes: a pedestal provided on an installation surface of the bed and including a first installation portion on which a guide rail configured to guide the saddle in the first direction is installed, and a second installation portion disposed on one end side of the guide rail and on which the column is installed; and a flow path provided on the installation surface of the bed, the flow path being configured to allow liquid dripping from the first installation portion to flow toward the second installation portion via an outer side of a side wall of the first installation portion that is located in the second direction, and wherein the second installation portion includes a protruding portion that protrudes from the side wall of the first installation portion that is located in the second direction, and a through hole through which the flow path passes is formed in the protruding portion.

According to the aspect of the invention, the protruding portion of the second installation portion can support the column from both sides of the flow path, and the rigidity of the pedestal on which the column is installed can be increased. Therefore, the rigidity of the machine tool can be increased.

### BRIEF DESCRIPTION OF DRAWINGS

FIG. 1 is a schematic diagram illustrating a configuration of a machine tool according to an embodiment;

FIG. 2 is a perspective view showing a bed and a pedestal;

FIG. 3 is a view of the bed and the pedestal viewed from above;

FIG. 4 is a side view of the bed and the pedestal; and

FIG. 5 is a view showing the bed and the pedestal viewed from the rear side.

### DESCRIPTION OF THE INVENTION

A preferred embodiment of the present invention will be described below, in detail, with reference to the accompanying drawings.

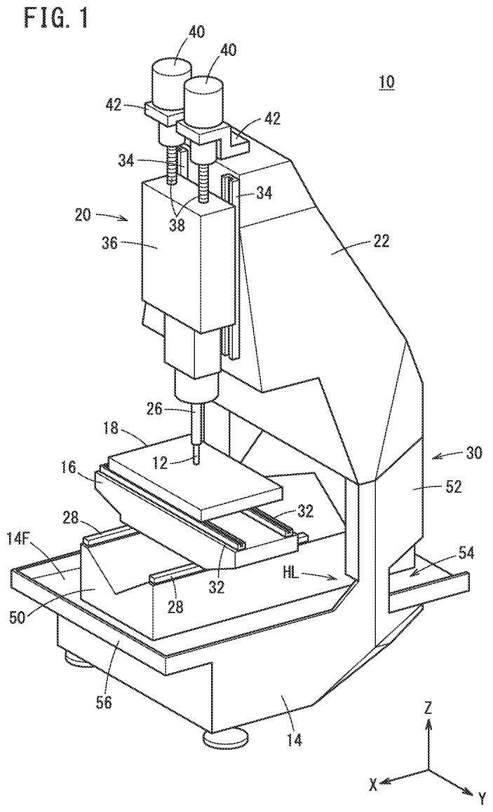

FIG. 1 is a schematic view showing a configuration of a machine tool 10 according to an embodiment. The machine tool 10 machines a workpiece with a tool 12. The machine tool 10 includes a bed 14, a saddle 16, a table 18, a spindle head 20, and a column 22.

The machine tool 10 machines a workpiece fixed to the table 18, by displacing the tool 12 attached to the tip of a spindle 26 in a state where the spindle 26 of the spindle head 20 is being rotated. When displacing the tool 12, the machine tool 10 relatively moves the saddle 16 in a first direction with respect to the bed 14, relatively moves the table 18 in a second direction with respect to the saddle 16, and relatively moves the spindle head 20 in a third direction with respect to the table 18 according to a machining program.

The first direction is an X direction corresponding to the X axis of a machine coordinate system defined in the machine tool 10. A forward direction (+X direction) of the X direction is defined as a front direction (front side), and a reverse direction (−X direction) opposite to the forward direction is defined as a rear direction (rear side).

The second direction is a direction intersecting with the first direction in a plane, and is a Y direction corresponding to the Y axis of the machine coordinate system defined in the machine tool 10. A forward direction (+Y direction) of the Y direction is a right direction (right side), and a reverse direction (−Y direction) opposite to the forward direction is a left direction (left side).

The third direction is a direction intersecting with each of the first direction and the second direction, and is a Z direction corresponding to the Z axis of the machine coordinate system defined in the machine tool 10. A forward direction (+Z direction) of the Z direction is defined as an upward direction (upper side), and a reverse direction (−Z direction) opposite to the forward direction is defined as a downward direction (lower side). The downward direction is the direction in which gravity acts.

The bed 14 is a member serving as a base of the machine tool 10. The bed 14 is provided on a foundation such as the ground or a floor. A surface opposite to the foundation side of the bed 14 is an installation surface 14F for installing an object thereon.

The saddle 16 is movably coupled to a guide rail 28 that guides the saddle 16 in the front-rear direction (X direction). The guide rail 28 is installed on an upper surface of a pedestal 30 provided on the installation surface 14F of the bed 14, and extends along the front-rear direction. The number of the guide rails 28 may be one or more. When multiple guide rails 28 are provided, the multiple guide rails 28 are arranged at intervals from each other. In the present embodiment, as shown in FIG. 1, a pair of guide rails 28 are installed on the upper surface of the pedestal 30.

The saddle 16 moves along the guide rail 28 in accordance with rotation of a saddle driving motor (not shown) controlled by a numerical control device of the machine tool 10, to thereby move in the front-rear direction relative to the bed 14. When the saddle driving motor rotates in the forward direction (or in the reverse direction), the saddle 16 relatively moves in the front direction. On the other hand, when the saddle driving motor rotates in the reverse direction (or in the forward direction), the saddle 16 relatively moves in the rear direction.

The table 18 is movably coupled to a guide rail 32 that guides the table 18 in the left-right direction (Y direction). The guide rail 32 is disposed on the upper surface of the saddle 16 and extends along the left-right direction. The number of the guide rails 32 may be one or more. When multiple guide rails 32 are provided, the multiple guide rails 32 are arranged at intervals from each other. In the present embodiment, as shown in FIG. 1, a pair of guide rails 32 are installed on the upper surface of the saddle 16.

The table 18 moves along the guide rail 32 in accordance with rotation of a table driving motor (not shown) controlled by the numerical control device of the machine tool 10, to thereby move in the left-right direction relative to the saddle 16. When the table driving motor rotates in the forward direction (or in the reverse direction), the table 18 relatively moves in the right direction. On the other hand, when the table driving motor rotates in the reverse direction (or in the forward direction), the table 18 relatively moves in the left direction.

The spindle head 20 is movably coupled to a guide rail 34 that guides the spindle head 20 in the up-down direction (Z direction). The guide rail 34 is installed on a front surface (a surface on the spindle head 20 side) of the column 22, and extends along the up-down direction. The number of the guide rails 34 may be one or more. When multiple guide rails 34 are provided, the multiple guide rails 34 are arranged at intervals from each other. In the present embodiment, as shown in FIG. 1, a pair of guide rails 34 are installed on the front surface of the column 22.

The spindle head 20 includes a spindle 26, a housing 36 through which the spindle 26 is inserted, and a bearing (not shown) that rotatably supports the spindle 26 with respect to the housing 36. The spindle 26 extends toward the table 18 below the spindle head 20, and rotates in accordance with rotation of a spindle driving motor (not shown) controlled by the numerical control device of the machine tool 10. The tool 12 attached to the tip of the spindle 26 rotates in conjunction with the rotation of the spindle 26.

The housing 36 is movably coupled to the pair of guide rails 34 and the pair of drive shafts 38, which extend in the up-down direction (Z direction). The pair of drive shafts 38 are ball screws for relatively moving the spindle head 20 in the up-down direction, and rotate in conjunction with a spindle head driving motor 40. The motor 40 is attached to a support member 42 that is fixed to the column 22.

The housing 36 moves along the drive shaft 38 through a nut (not shown) screw-engaged with the drive shaft 38 in accordance with the rotation of the drive shaft 38 caused by the motor 40, and also moves along the guide rail 34. Accordingly, the spindle 26 rotatably supported with respect to the housing 36 moves in the up-down direction. That is, the spindle head 20 moves along the guide rail 34 in accordance with the rotation of the motor 40, to thereby move in the up-down direction relative to the table 18. When the motor 40 rotates in the forward direction (or the reverse direction), the spindle head 20 relatively moves in the upward direction. On the other hand, when the motor 40 rotates in the reverse direction (or in the forward direction), the spindle head 20 relatively moves in the downward direction.

The column 22 supports the spindle head 20. The column 22 is installed on the pedestal 30. Since the column 22 is installed on the pedestal 30, the height (vertical dimension) of the column 22 is shorter than in a case where the column 22 is installed on the installation surface 14F of the bed 14. Therefore, it is possible to reduce the load applied to the joint portion between the column 22 and the pedestal 30.

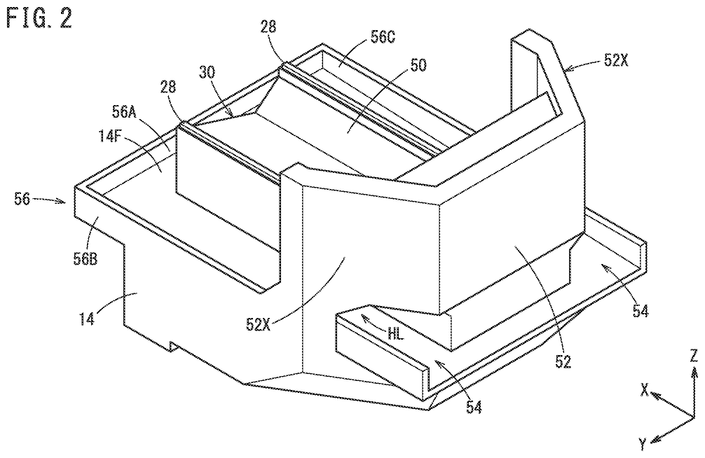

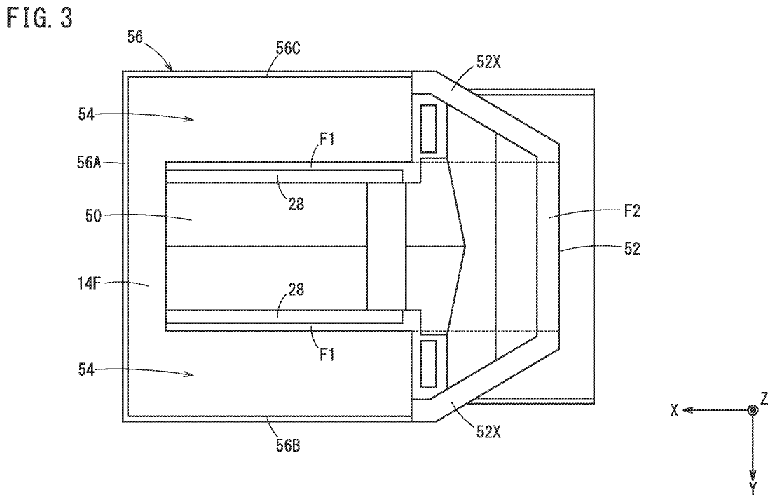

Next, the bed 14 and the pedestal 30 will be described in more detail with reference to FIGS. 2 to 5. The pedestal 30 has a first installation portion 50 and a second installation portion 52. The first installation portion 50 is a portion of the pedestal 30 on which the guide rails 28 are installed. The first installation portion 50 is disposed substantially at the center of the bed 14 in the left-right direction. The second installation portion 52 is a portion of the pedestal 30 on which the column 22 is installed. The second installation portion 52 is disposed on one end side (rear end side) of the guide rail 28 installed on the first installation portion 50.

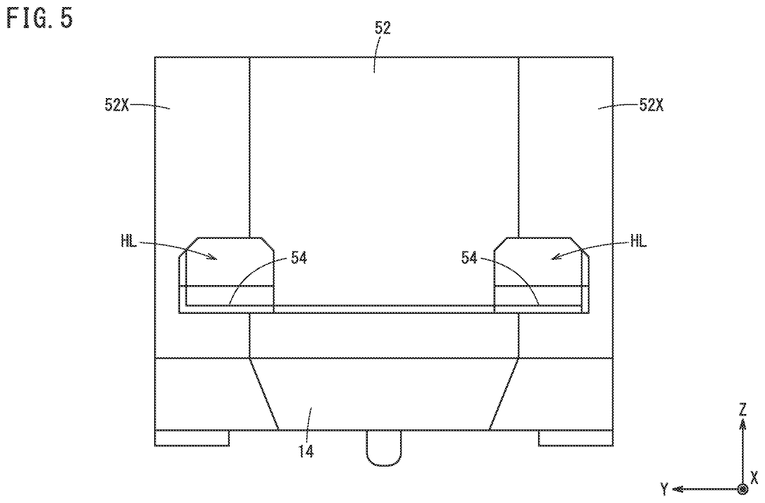

The second installation portion 52 includes a protruding portion 52X that protrudes from each of the side walls of the first installation portion 50 that are located in the left and right directions. The protruding portion 52X protruding from the right side wall of the first installation portion 50 has a wall surface flush with the wall surface of the right side wall of the bed 14 (see FIGS. 2 and 5). On the other hand, the protruding portion 52X protruding from the left side wall of the first installation portion 50 has a wall surface flush with the wall surface of the left side wall of the bed 14 (see FIGS. 2 and 5). Owing thereto, the rigidity of the pedestal 30 can be increased compared to a case in which the side walls of the left and right protruding portions 52X are positioned on the outer side or the inner side of the wall surfaces of the left-right side walls of the bed 14.

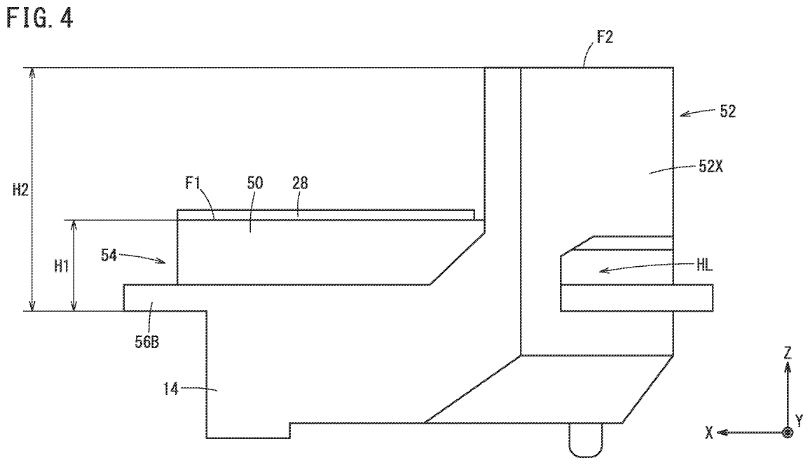

The height H2 from the installation surface 14F of the bed 14 to the installation surface F2 of the second installation portion 52 is higher than the height H1 from the installation surface 14F of the bed 14 to the installation surface F1 of the first installation portion 50 (see FIG. 4). Accordingly, the height of the column 22 (the dimension in the up-down direction) is shorter than in a case where the height H2 of the second installation portion 52 is the same as the height H1 of the first installation portion 50. Therefore, it is possible to reduce the load applied to the joint portion between the column 22 and the second installation portion 52.

On the installation surface 14F of the bed 14 on which the pedestal 30 is provided, a flow path 54 that allows fluid dripping from the first installation portion 50 to flow therethrough is provided. In a case where an oil bearing is formed between the guide rail 28 and the saddle 16 (FIG. 1), the fluid dripping from the first installation portion 50 contains oil. In a case where cutting fluid is sprayed onto the workpiece during machining, the fluid dripping from the first installation portion 50 contains the cutting fluid.

The flow path 54 allows fluid to flow to the second installation portion 52 side (rear side) via the outside of each of the side walls of the first installation portion 50 that are located in the left and right directions. The flow path 54 may be formed by inclining the installation surface 14F of the bed 14 from the front side toward the rear side, may be a groove formed in the installation surface 14F of the bed 14, or may be a member fitted into the groove. Note that each of FIGS. 2 to 5 illustrates a flow path 54 formed by the installation surface 14F of the bed 14 being inclined from the front side toward the rear side.

When the flow path 54 formed by the installation surface 14F of the bed 14 being inclined from the front side toward the rear side is adopted, a surrounding portion 56 that surrounds the front side, the left side, and the right side of the installation surface 14F of the bed 14 is formed. The surrounding portion 56 includes a front wall 56A provided along a front edge of the installation surface 14F of the bed 14, a right wall 56B provided along a right edge of the installation surface 14F, and a left wall 56C provided along a left edge of the installation surface 14F. Front ends of the right wall 56B and the left wall 56C are connected to the front wall 56A, and rear ends of the right wall 56B and the left wall 56C are connected to the protruding portion 52X.

A through hole HL through which the flow path 54 passes is formed in each of the left and right protruding portions 52X (see FIGS. 2, 4, and 5). Accordingly, the protruding portion 52X of the second installation portion 52 can support the column 22 from both sides of the flow path 54, and the rigidity of the pedestal 30 on which the column 22 is installed can be increased. In a case where the through hole HL penetrates the protruding portion 52X along the front-rear direction, it is possible to increase the occupancy of the protruding portion 52X per unit volume, in comparison with, for example, a case where the through hole HL does not penetrate the protruding portion 52X along the front-rear direction, such as when the through hole HL meanders. Therefore, when the through hole HL penetrates the protruding portion 52X along the front-rear direction, it is possible to further increase the rigidity of the pedestal 30.

[Invention]

The invention that can be understood from the above embodiment will be described below.

The machine tool (10) includes: a saddle (16) configured to move relative to a bed (14) in a first direction; a table (18) configured to move relative to the saddle (16) in a second direction intersecting with the first direction; a spindle head (20) configured to move relative to the table (18) in a third direction intersecting with the first direction and the second direction; and a column (22) configured to support the spindle head (20). The machine tool (10) further includes a pedestal (30) provided on an installation surface (14F) of the bed (14) and including a first installation portion (50) on which a guide rail (28) configured to guide the saddle (16) in the first direction is installed, and a second installation portion (52) disposed on one end side of the guide rail (28) and on which the column (22) is installed; and a flow path (54) provided on the installation surface (14F) of the bed (14), the flow path (54) being configured to allow liquid dripping from the first installation portion (50) to flow toward the second installation portion (52) via an outer side of a side wall of the first installation portion (50) that is located in the second direction. The second installation portion (52) includes a protruding portion (52X) that protrudes from the side wall of the first installation portion (50) that is located in the second direction, and a through hole (HL) through which the flow path (54) passes is formed in the protruding portion (52X).

With the above configuration, the protruding portion (52X) of the second installation portion (52) can support the column (22) from both sides of the flow path (54), and the rigidity of the pedestal (30) on which the column (22) is installed can be increased. Therefore, the rigidity of the machine tool (10) can be increased.

The protruding portion (52X) may have a wall surface that is flush with a wall surface of a side wall of the bed (14) that is located in the second direction. Thus, the rigidity of the pedestal (30) can be increased as compared with the case where the side walls of the protruding portion (52X) that is located in the second direction are located outside or inside the wall surfaces of the side walls of the bed (14) that are located in the left and right directions.

The height (H2) from the installation surface (14F) of the bed (14) to the installation surface (F2) of the second installation portion (52) may be higher than the height (H1) from the installation surface (14F) of the bed (14) to the installation surface (F1) of the first installation portion (50). Thus, the height of the column (22) can be reduced as compared with the case where the height (H2) of the second installation portion (52) is the same as the height (H1) of the first installation portion (50). Therefore, it is possible to reduce the load applied to the joint portion between the column (22) and the second installation portion (52).

1. A machine tool comprising: a saddle configured to move relative to a bed in a first direction; a table configured to move relative to the saddle in a second direction intersecting with the first direction; a spindle head configured to move relative to the table in a third direction intersecting with the first direction and the second direction; and a column configured to support the spindle head, wherein the machine tool further comprises:
a pedestal provided on an installation surface of the bed and including a first installation portion on which a guide rail configured to guide the saddle in the first direction is installed, and a second installation portion disposed on one end side of the guide rail and on which the column is installed; and
a flow path provided on the installation surface of the bed, the flow path being configured to allow liquid dripping from the first installation portion to flow toward the second installation portion via an outer side of a side wall of the first installation portion that is located in the second direction, and
wherein
the second installation portion includes a protruding portion that protrudes from the side wall of the first installation portion that is located in the second direction, and
a through hole through which the flow path passes is formed in the protruding portion.

2. The machine tool according to claim 1, wherein
the protruding portion includes a wall surface that is flush with a wall surface of a side wall of the bed that is located in the second direction.

3. The machine tool according to claim 1, wherein
a height from the installation surface of the bed to an installation surface of the second installation portion is higher than a height from the installation surface of the bed to an installation surface of the first installation portion.
